(19) United States
(12) Patent Application Publication
(10) Pub. No.: US 2013/0090793 A1
(43) Pub. Date: Apr. 11, 2013

(54) RELAY FUSION DETECTING TECHNIQUE FOR HIGH VOLTAGE BATTERY SYSTEM OF VEHICLE

(71) Applicants: Do Sung Hwang, Gunpo (KR); Hyun Soo Park, Hwaseong (KR); Kyung In Min, Seoul (KR)

(72) Inventors: Do Sung Hwang, Gunpo (KR); Hyun Soo Park, Hwaseong (KR); Kyung In Min, Seoul (KR)

(73) Assignees: KIA MOTORS CORPORATION, Seoul (KR); HYUNDAI MOTOR COMPANY, Seoul (KR)

(21) Appl. No.: 13/323,676

(22) Filed: Dec. 12, 2011

(30) Foreign Application Priority Data
Oct. 5, 2011 (KR) 10-2011-0100996

(51) Int. Cl. G05F 5/00; G01N 27/416

(52) U.S. Cl. 701/22; 324/426; 180/65.29; 903/903

(57) ABSTRACT

Disclosed is a technique for detecting a relay fusion in a battery system. In particular, the disclosed technique protects the battery system by being able to determine whether all of the relays in the battery system are fused without any omission. In particular, the disclosed technique alternates between two processes to ensure all relays are operating correctly.

### CROSS-REFERENCE TO RELATED APPLICATION

This application claims under 35 U.S.C. §119(a) the benefit of Korean Patent Application No. 10-2011-0100996 filed on Oct. 5, 2011, the entire contents of which are incorporated herein by reference.

### BACKGROUND

(a) Technical Field

The present invention relates to a relay fusion detecting technique that controls current supplied to a high voltage battery system mounted within a vehicle.

(b) Background Art

High voltage battery systems are mounted within electrically powered vehicles such hybrid vehicles or electric vehicles. These high voltage batteries typically include a relay to interrupt current of a high voltage battery in order to achieve a certain degree of safety and protect the system. These relays are generally connected during IG ON and terminated/disconnected during IG OFF.

Both contacts of the relay as described above serve as switches and may adhere to each other due to overcurrent. This happens it is often referred to as relay fusion. The conventional current interruption operation of the high voltage battery system cannot be performed when fusion occurs, and as a result, the fusion of the relay is detected during every IG ON of the vehicle.

FIG. 1 shows a high voltage battery system of a vehicle used in a conventional design. A high voltage battery 500 is connected to a high voltage load (V_load) through a positive relay (RLY_pos) and a negative relay (RLY_neg), and a pre-relay (RLY_pre) and a precharge resistor 510 is connected to the positive relay (RLY_pos) in parallel.

The relay fusion detecting technique in the conventional art will be described below. As shown in FIG. 2, after the negative relay RLY_neg is first connected, the pre-relay RLY_pre is connected and thereafter, the positive relay RLY_pos is connected. While the relays are connected in sequence according to such a sequence, the fusion of the relay is detected depending on whether load current is detected when the pre-relay RLY_pre is connected. Therefore, the state of FIG. 2 shows a normal status. That is, when the pre-relay RLY_pre is connected after the negative relay RLY_neg is connected, the load current is slowly increased by the precharge resistor 510. Subsequently, when the positive relay RLY_pos is connected, the load current flows as rated current. Thereafter, the pre-relay RLY_pre is cut off.

However, if the pre-relay RLY_pre is fused, when the negative relay RLY_neg, the pre-relay RLY_pre, and the positive relay RLY_pos are connected in sequence, the load current slowly increases at the same time when the negative relay RLY_neg is connected as shown in FIG. 3. Therefore, since significant load current has been already detected when the pre-relay RLY_pre is connected, whether the pre-relay RLY_pre is fused can be detected based on the magnitude of the load current when the pre-relay RLY_pre is connected.

Further, if the positive relay RLY_pos is fused, the load current significantly increases from the time when the negative relay RLY_neg, and as a result, current of a rated current level has been already detected as the load current at the time when the pre-relay RLY_pre is connected, as shown in FIG. 4.

As described above, whether the pre-relay RLY_pre and the positive relay RLY_pos are fused can be determined by judging the magnitude of the load current at the time when the pre-relay RLY_pre is connected when the negative relay RLY_neg, the pre-relay RLY_pre, and the positive relay RLY_pos are sequentially connected. When the negative relay RLY_neg is fused, the behavior of the load current is the same as that shown in FIG. 2, and the magnitude of the load current cannot be detected.

For reference, when all the relays are fused all at once, the magnitude of the load current is basically judged as the magnitude of the load current at a first relay connection point of time.

### SUMMARY OF THE DISCLOSURE

The present invention has been made in an effort to solve the above-described problems associated with prior art.

In one aspect, the present invention provides a relay fusion detecting technique in this case a method, apparatus and system for a high voltage battery system of a vehicle in which two relays connected in series to each other are connected sequentially within a time interval and thereafter, while a relay connected to one of the two relays in parallel is connected, when a relay connected later between the two relays connected in series is connected, when the fusion of the relays is detected by judging the magnitude of load current., whenever the fusion of each relay is detected, the fusion of the relays are detected while changing connection sequences of the two relays connected in series each other.

In another aspect, the present invention provides a relay fusion detecting method for a high voltage battery system of a vehicle; including: a first process, executed by a controller or control unit, including a first step that connects a negative relay connected to a negative electrode of a high voltage battery, a second step that connects a pre-relay connected to a positive relay connected to a positive electrode of the high voltage battery after a predetermined time elapses from the first step, and a third step of detecting whether the pre-relay and the positive relay are fused by judging the magnitude of load current when the pre-relay is connected while the positive relay is cut off; and a second process including a fourth step that connects the pre-relay, a fifth step that connects the negative relay after a predetermined time elapses from the fourth step, and a sixth step that detects whether the negative relay is fused by judging the magnitude of load current when the negative relay is connected while the positive relay is cut off, wherein the first process and the second process are performed in an alternating sequence whenever the relay is fused.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing a high voltage battery system of a vehicle in prior art;

FIG. 2 shows a relay fusion detecting method for a high voltage battery system of a vehicle in prior art and is a diagram showing a behavior in a normal state;

FIG. 3 is a diagram describing a principle of detecting a fusion of a pre-relay by using the method of FIG. 2;

FIG. 4 is a diagram describing a principle of detecting a fusion of a positive relay by using the method of FIG. 2;

FIG. 5 is a flowchart showing a relay fusion detecting method for a high voltage battery system of a vehicle according to an exemplary embodiment of the present invention; and

FIG. 6 is a diagram describing a principle of detecting a fusion of a negative relay through a second process performed in the present invention.

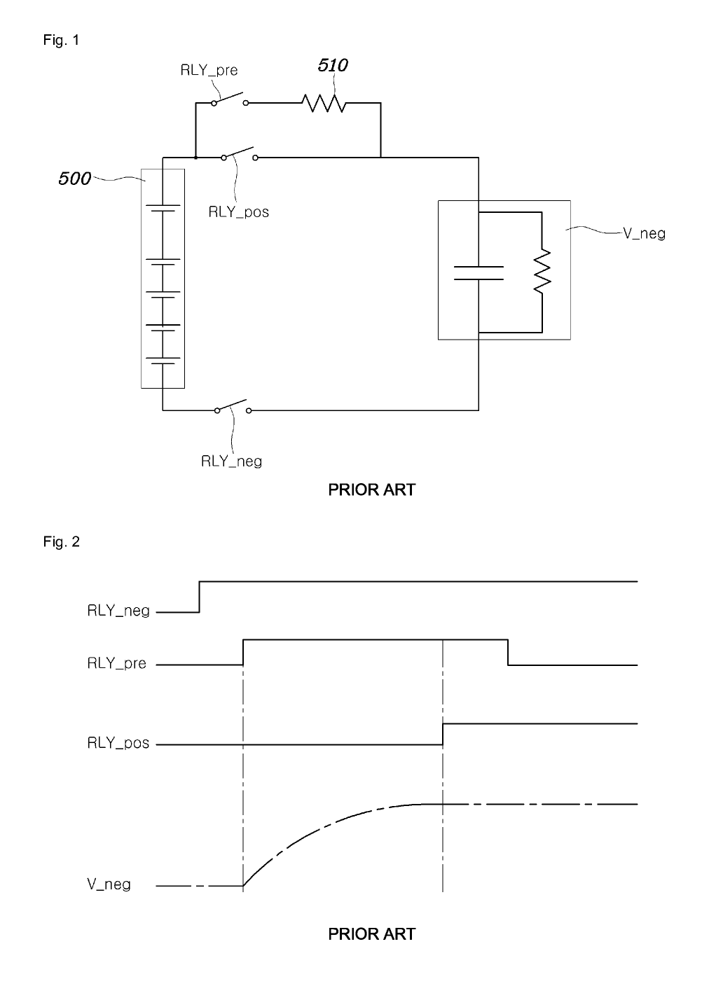

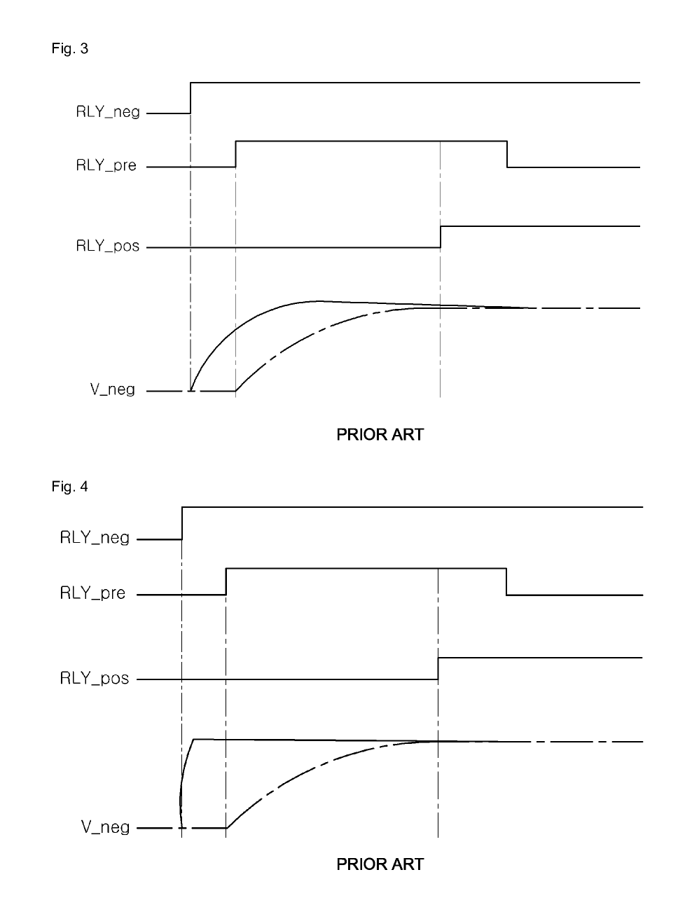

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

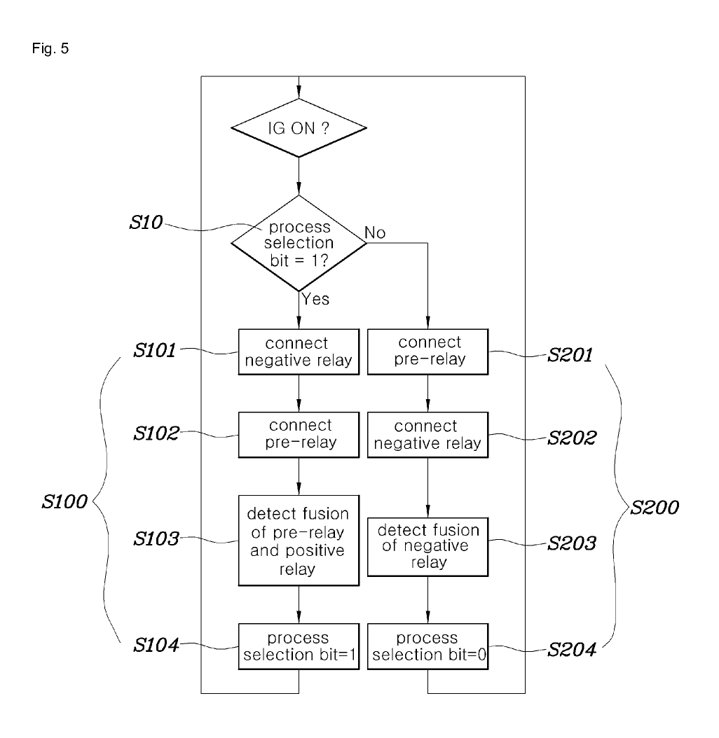

Referring to FIG. 5, an exemplary embodiment of the present invention includes: a first process (S100) including a first step (S101) that is executed when a process selection bit is 1 and is configured to connect a negative relay connected to a negative electrode of a high voltage battery, a second step (S102) of connecting a pre-relay connected to a positive relay connected to a positive electrode of the high voltage battery after a predetermined time elapses from the first step (S101) and the first step has not been completed, and a third step (S103) of detecting whether the pre-relay and the positive relay are fused by judging the magnitude of load current when the pre-relay is connected while the positive relay is cut off.

A second process (S200) including a fourth step (S201) that connects the pre-relay when a process selection bit is not 1, a fifth step (S202) that connects the negative relay after a predetermined time elapses from the fourth step (S201), and a sixth step (S203) that detects whether the negative relay is fused by judging the magnitude of load current when the negative relay is connected when the positive relay is cut off The first process (S100) and the second process (S200) are performed in an alternating sequence whenever a relay fusion is detected.

That is, two relays RLY_neg and RLY_pre connected in series to each other are connected sequentially within a time interval and thereafter, while a relay RLY_pos connected to one RLY_pre of the two relays in parallel is connected, when a relay connected later between the two relays RLY_neg and RLY_pre connected in series is connected, the fusion of the relays is detected by judging the magnitude of the load current thereover. In this case, whenever the fusion of each relay is detected, the fusion of the relays is detected while changing connection sequences of the two relays connected in parallel each other.

Whether the relay is fused or not is detected at every IG ON of a vehicle and process selection bits are different from each other in the first process (S100) and the second process (S200) (S104 and S204) so that the first process (S100) and the second process (S200) are alternately performed one by one every continuously. The first process (S100) or the second process (S200) is configured to be selected depending on the process selection bit during subsequent IG ONs.

The process selection bit may be stored in a nonvolatile memory which is not erased even in an IG OFF state in which ignition of the vehicle is off. Therefore, when ignition of a controller is on, the first process (S100) or the second process (S200) is performed depending upon a value of the process selection bit to alternately detect whether other relays are fused.

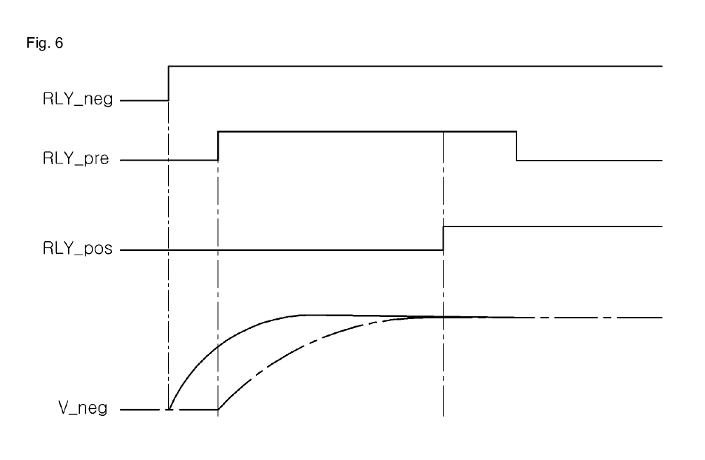

The first process (S100) is the same as that in conventional art and the second process (S200) is performed as shown in FIG. 6. Therefore, when the negative relay is fused, the fusion of the negative relay is judged by the magnitude of load current which has already increased to a significant level at the time of the negative relay is connected as shown in FIG. 6.

As described above, when the first process (S100) and the second process (S200) are alternately performed whenever the ignition of the vehicle commenced, the illustrative embodiment of the present invention determines whether all the relays of the high voltage battery system are fused to improve safety and protect the high voltage battery more advantageously.

According to exemplary embodiments of the present invention, all relays provided to control current of a battery system can be monitored without omission to secure more improved safety and protect the battery system.

Furthermore, the control logic of the present invention may be embodied as computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A relay fusion detecting system for a high voltage battery system of a vehicle, comprising:
two relays connected sequentially in serires over a time interval and wherein thereafter a relay connected to one of the two relays in parallel is connected, and when a relay connected to the later between the two relays connected in series is connected,
a controller configured to detect the fusion of at least two relays by judging the magnitude of load current, whenever the fusion of each relay is detected, the fusion of the relays are detected while changing connection sequences of the two relays connected in series each other.

2. The relay fusion detecting system for a high voltage battery system of a vehicle of claim 1, wherein whether the relay is fused is detected at every IG ON of a vehicle.

3. A relay fusion detecting method for a high voltage battery system of a vehicle, comprising:
in response to determining a first bit has been selected, a first process which includes connecting, by a controller, a negative relay connected to a negative electrode of a high voltage battery, connecting by the controller, a pre-relay connected to a positive relay connected to a positive electrode of the high voltage battery after a predetermined time elapses from connecting the negative relay to the negative electrode, and detecting by the controller, whether the pre-relay and the positive relay are fused together by judging the magnitude of load current when the pre-relay is connected while the positive relay is cut off; and
in response to determining that the predetermined bit has not been selection, performing a second process which includes connecting, by the controller, the pre-relay, connecting, by the controller, the negative relay after a predetermined time elapses after connecting the pre-lay, and detecting whether the negative relay is fused by judging the magnitude of load current when the negative relay is connected while the positive relay is cut off,
wherein the first process and the second process are performed in an alternating sequence whenever the relay is fused.

4. The relay fusion detecting method for a high voltage battery system of a vehicle of claim 3, wherein whether the relay is fused is detected every IG ON of a vehicle, process selection bits are different from each other in the first process and the second process so that the first process and the second process are alternately performed one by one every time a series of IG ONs which are continued, and the first process or the second process is configured to be selected depending on the process selection bit during subsequent IG ON.

5. The relay fusion detecting method for a high voltage battery system of a vehicle of claim 4, wherein the process selection bit may be stored in a nonvolatile memory which is not erased even in an IG OFF state in which ignition of the vehicle is off.

6. A computer readable medium containing program instructions which are executed on a controller, the computer readable medium comprising:
program instructions that determine whether a predetermined bit has been selected;
program instruction that performs a first processs in response to determining a first bit has been selected:
connect a negative relay connected to a negative electrode of a high voltage battery,
connect a pre-relay connected to a positive relay connected to a positive electrode of the high voltage battery after a predetermined time elapses from connecting the negative relay to the negative electrode, and
detect whether the pre-relay and the positive relay are fused together by judging the magnitude of load current when the pre-relay is connected while the positive relay is cut off; and
program instructions that performs a second process in response to determining that the predetermined bit has not been selection,
connect the pre-relay,
connect the negative relay after a predetermined time elapses after connecting the pre-lay, and
detect whether the negative relay is fused by judging the magnitude of load current when the negative relay is connected while the positive relay is cut off,
wherein the first process and the second process are performed in an alternating sequence whenever the relay is fused.
